(19) United States
(12) Patent Application Publication
(10) Pub. No.: US 2020/0354996 A1
(43) Pub. Date: Nov. 12, 2020

(54) DOOR HANDLE ASSEMBLY OF A VEHICLE DOOR

(71) Applicants: Christian Bresser, Leichlingen (DE); Michael Rhein, Moenchengladbach (DE); Bernd Reifenberg, Essen (DE)

(72) Inventors: Christian Bresser, Leichlingen (DE); Michael Rhein, Moenchengladbach (DE); Bernd Reifenberg, Essen (DE)

(73) Assignee: Huf Huelsbeck & Fuerst GmbH & Co. KG, Velbert (DE)

(21) Appl. No.: 16/771,621

(22) PCT Filed: Oct. 19, 2018
(86) PCT No.: PCT/EP2018/078702

§ 371 Date: Jun. 10, 2020

(30) Foreign Application Priority Data
Dec. 14, 2017 (DE) 10 2017 130 031.7

(51) Int. Cl. E05B 85/10

(52) U.S. Cl. CPC E05B 85/107; E05Y 2900/531; E05B 85/103

(57) ABSTRACT

A door handle assembly of a vehicle door includes a handle support, a handle which runs flush with the outer contour of the vehicle door in a non-use position and which is movable into an actuation position, a first lifting mechanism and a second lifting mechanism, each of which is coupled to the handle so as to transmit a movement. The handle protrudes relative to the outer contour of the vehicle door in the actuation position. The first lifting mechanism has a first pivot axis arranged on the handle support and a first joint axis. The second lifting mechanism has a second joint axis and a second pivot axis which is arranged on the support and is coupled to the first lifting mechanism via a coupling rod so as to transmit a movement. The first pivot axis or second pivot axis is driven by a motor.

The invention relates to a door handle assembly of a vehicle door, having a handle support which can be secured to the vehicle door, a handle which is mounted on the handle support and arranged so as to run flush with the outer contour of the vehicle door in a non-use position and which is designed to be movable into an actuation position by a user for actuation, and a first lever mechanism which is coupled to the first longitudinal end of the handle so as to transmit a movement, and a second lever mechanism which is coupled to the second longitudinal end of the handle so as to transmit a movement, wherein the handle is arranged so as to protrude relative to the outer contour of the vehicle door in the actuation position in comparison to the non-use position and can be actuated by the user in order to open the vehicle door, and wherein the first lever mechanism has a first pivot axis which is arranged on the handle support.

Door handle assemblies in which the handle extends flush with the outer contour of the vehicle door in its non-use position are known from the prior art. The handle may thereby be designed as an inner or outer handle in the case of these types of door handle assemblies for a vehicle door of a motor vehicle, wherein the present invention relates to a door handle assembly for an outer handle. For this type of door handle assembly, there is a variety of different constructions and embodiments. The door handle assembly according to the invention relates to such constructions in which a handle support is secured to the rear of the vehicle door, i.e. inside the motor vehicle. In such embodiments, the handle attached to the handle support usually protrudes from the vehicle door and disturbs both the aesthetic impression of the vehicle and the vehicle aerodynamics. In order to avoid these disadvantages, there are known prior art door handle assemblies in which the outside of the handle in its non-use position, i.e. in which it is not used, extends approximately flush with the outer contour of the vehicle door, i.e. flush with the edge. Such a handle can be transferred to an actuation position for opening the vehicle door or an on-board lock, in which the handle protrudes compared to the outer contour of the vehicle door. The handle is extended using a motor when a legitimate user approaches the vehicle. Once the handle is no longer needed, it returns to the non-use position and disappears into the vehicle body to avoid producing air resistance. As is known, the movement of the handle is realized with the aid of a first lever mechanism and a second lever mechanism, which couple the respective longitudinal ends of the handle to the handle support. A disadvantage of such door handle assemblies of the type described at the outset is the limited installation space, since the overall depth of the door, i.e. the extension from the outside of the door to the inside of the door, generally also has to take into account the depth which is required so that the window pane can be guided past the handle support when it is opened and the lever mechanism does not get into the movement path of the window pane during a movement of the handle from the non-use position into the actuation position. The depth for countersinking the window pane can hardly be reduced, so that the installation depth of the door handle assembly decisively determines the overall depth of the door.

The invention has for its object to develop a door handle assembly of a vehicle door in a structurally simple and inexpensive manner, which has a small installation depth and through which the overall depth of the door can be reduced.

In the case of a door handle assembly of the type described in the introduction, this object is achieved according to the invention in that the first lever mechanism has a first joint axis which is arranged on the handle, and the second lever mechanism has a second joint axis which is coupled to the handle so as to transmit a movement, and has a second pivot axis which is arranged on the support and which is coupled to the first lever mechanism via a coupling rod so as to transmit a movement, the first pivot axis or the second pivot axis being driven by a motor.

Advantageous and expedient embodiments and developments of the invention are disclosed in the dependent claims.

The invention provides a door handle assembly in a structurally simple and inexpensive manner, by means of which the overall depth of the door can be reduced to a minimum. Because the first lever mechanism and the second lever mechanism are coupled together so as to transmit a movement via a coupling rod in the manner of a cam disc kinematic system or thrust crank kinematic system, it is possible to accommodate the required kinematic processes in the smallest and tightest installation space, which are necessary for moving the handle from the non-use position to the actuation position and back to the non-use position. The kinematic system formed by the first lever mechanism and the second lever mechanism increases the efficiency of the door handle assembly according to the invention, because this design has a high degree of rigidity with increased acceleration values for the movement of the handle in comparison to known door handle assemblies, wherein the movement of the door handle arrangement according to the invention takes place at a high level of accuracy.

In an embodiment, the invention provides that the first lever mechanism has a pivot lever element having a first pivot arm and a second pivot arm, wherein the first pivot arm is connected in an articulated manner to the first joint axis and the second pivot arm is connected in an articulated manner to the coupling rod.

It is particularly advantageous with regard to dynamic kinematics with a small installation space if the second lever mechanism has a movement lever which is pivotably mounted on the second pivot axis and which is coupled to the coupling rod via the second joint axis so as to transmit a movement.

In an embodiment of a first embodiment, the invention provides that the movement lever is rotatably connected to the second pivot axis and a cam disc drives the second pivot axis for moving the handle, whereby the movement lever pivots in a direction pointing away from the first pivot axis during the movement of the handle from the non-use position into the actuation position, wherein the coupling rod pivots the pivot lever element about the first pivot axis such that the first joint axis moves in an opening direction of the handle.

For a second embodiment, the invention provides in an embodiment that the first pivot axis and the second pivot axis are linearly movable along a longitudinal direction of the handle on the handle support, whereby a push crank drives the first pivot axis and moves linearly for moving the handle.

It is also advantageous for the second embodiment if the first pivot axis and the second pivot axis are coupled together so as to transmit a movement via the coupling rod, such that a movement of the first pivot axis moves also the second pivot axis.

In a further embodiment of the second embodiment, it has a kinematically favorable effect if the first lever mechanism has a first extension lever, which couples the first pivot axis to the first joint axis.

The installation space can be kept small in the second embodiment in that, in an embodiment of the invention, the second lever mechanism has a second extension lever, which couples the second pivot axis to the second joint axis.

Finally, in an embodiment of the second embodiment, it is advantageous if the push crank moves the first pivot axis and the second pivot axis linearly and thereby presses the first and the second extension lever in an opening direction of the handle when the handle moves from the non-use position into the actuation position.

It is self-evident that the features mentioned above and yet to be described below can be used not only in the combination described but also in other combinations or in isolation without departing from the scope of the present invention. The scope of the invention is defined only by the claims.

Other details, features, and advantages of the subject matter of the invention can be found in the following description in connection with the drawing, in which preferred embodiments of the invention are presented by way of example. In the drawing:

FIG. 1 is a side view of a motor vehicle having a door handle assembly according to the invention,

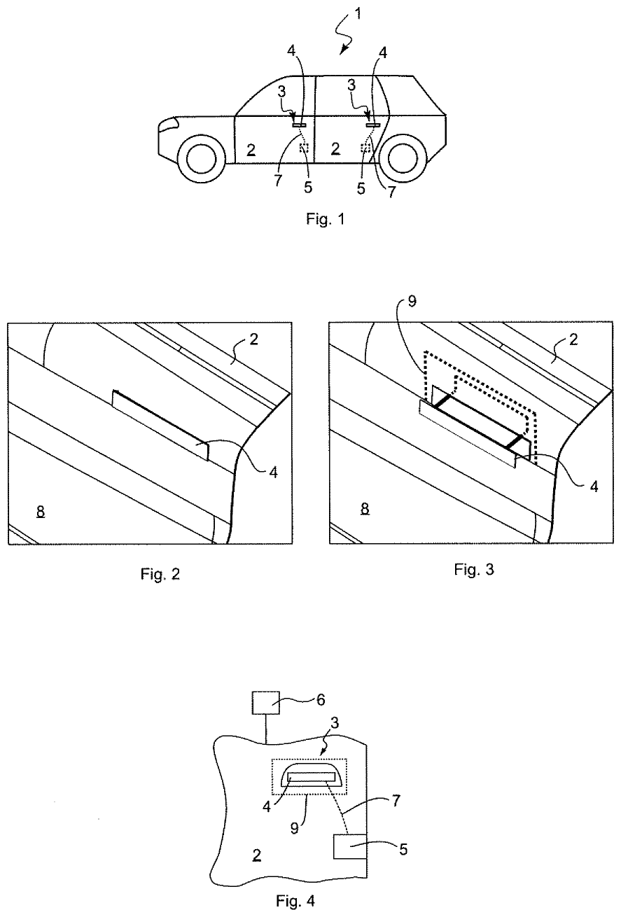

FIG. 2 shows a perspective view of a vehicle door of the motor vehicle, in which a handle of the door handle assembly according to the invention is arranged flush with an outer contour of the vehicle door in a non-use position,

FIG. 3 is a perspective view of the vehicle door of the motor vehicle, in which the handle of the door handle assembly according to the invention is arranged in an actuation position in which the handle is displaced parallel to the non-use position and protrudes with respect to the outer contour of the vehicle door,

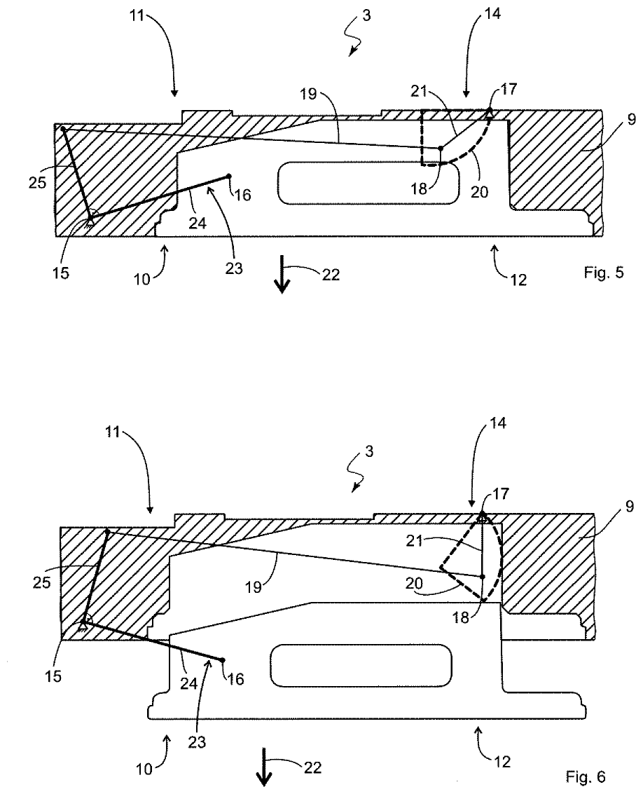

FIG. 4 is a schematic illustration of the vehicle door having the door handle assembly arranged thereon, a door lock and a locking system,

FIG. 5 is a schematic top view of a door handle assembly according to a first embodiment of the invention, in which the handle is arranged in the non-use position,

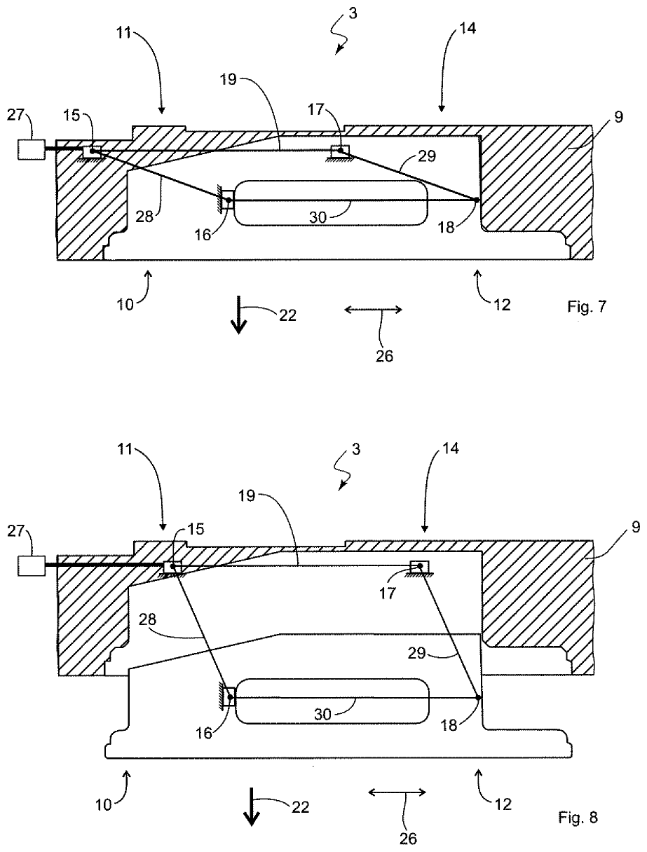

FIG. 6 is a schematic top view of the door handle assembly according to the first embodiment of the invention, in which the handle is arranged in the actuation position,

FIG. 7 is a schematic top view of a door handle assembly according to a second embodiment of the invention, in which the handle is arranged in the non-use position,

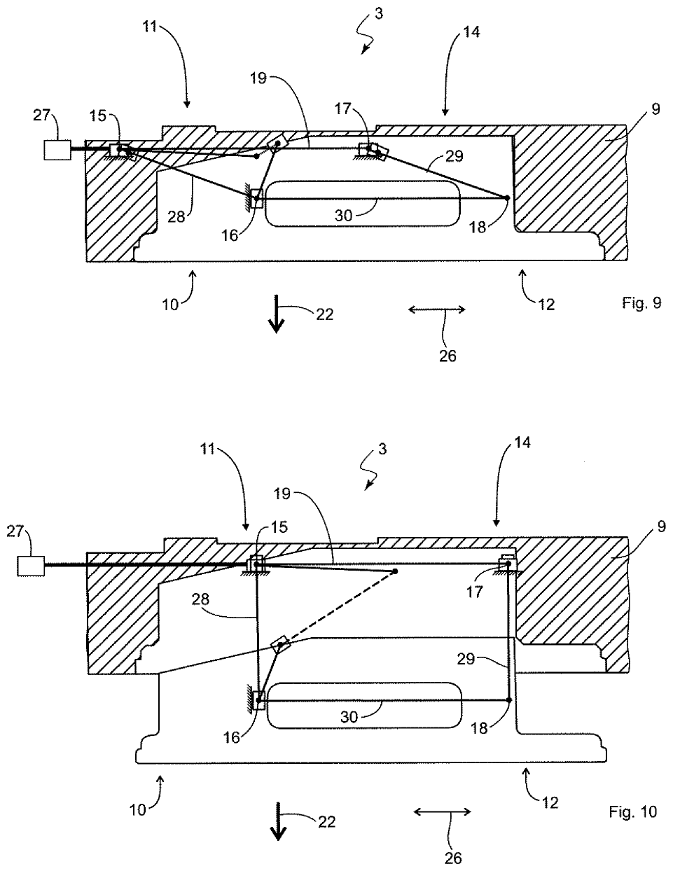

FIG. 8 shows a schematic top view of the door handle assembly according to the second embodiment of the invention, in which the handle is arranged in the actuation position,

FIG. 9 is a schematic top view of a door handle assembly according to an alternative for the second embodiment of the invention, in which the handle is arranged in the non-use position, and

FIG. 10 shows a schematic top view of the door handle assembly according to the alternative for the second embodiment of the invention, in which the handle is arranged in the actuation position.

FIG. 1 shows a vehicle or motor vehicle 1 in the form of a car by way of example having four doors 2 in the example (two of which can be seen in FIG. 1), which can be opened via a door handle assembly 3 and in particular with the aid of a handle 4. With reference to FIGS. 1 to 3, the doors 2 are closed by respective door locks 5 and can be opened from the outside by a respective actuation of the handle 4. The handle 4 is actuated to open the door lock 5, the actuation in the exemplary embodiments shown in the drawings being a pulling force exerted by the user on the handle 4. To open the door 2, the handle 4 is then either pulled in normal operation or the handle 4 is pivoted to a specific degree, whereby a switch is actuated, which in turn activates an electromechanical locking system 6 (see FIG. 4), with the aid of which the door lock 5 can then be opened electrically. When the handle 4 is actuated to electrically open the door lock 5, the handle 4 is moved out of an actuation position. The electrical opening can take place before the end position of the handle 4 is reached. In the case of a current-operated normal operation, a slight pulling movement on the handle 4 is consequently sufficient for a Bowden cable system 7, which is shown in FIG. 1 by way of example, to be operated electrically for unlocking the door lock 5. In the case of a currentless emergency operation, the door handle assembly 3 can be formed such that manual unlocking of the door lock 5 and thereby manual opening of the vehicle door 2 is possible by actuation of the handle 4 effected by a user, wherein the handle 4 must be deflected or actuated past the deflection which is necessary in the normal operation. FIG. 2 shows in perspective view one of the vehicle doors 2 and the handle 4 which serves for the opening of the vehicle door 2. In FIG. 2, the handle 4 is arranged approximately flush with the outer contour 8 of the vehicle door 2, i.e. flush with the edge, when the door handle assembly 3 is installed in the vehicle door 2. In this position the handle 4 is in a non-use position in which it is not used. From the non-use position shown in FIG. 2, it is possible to transfer the handle 4 to an actuation position shown in FIG. 3 in which it protrudes compared to the outer contour 8 of the vehicle door 2, such that the handle 4 is arranged in its actuation position to protrude from the vehicle door 2. In this protruding actuation position or when extended from the outer contour 8, a user can reach behind the handle 4 and actuate or handle to open the vehicle door 2 or unlock the vehicle door lock 5. According to the present invention, the handle 4 is transferred from the non-use position into the actuation position in a current-operated normal operation by means of a suitable drive means, wherein for the current-operated normal operation, proximity sensors or other sensors may be provided to move the handle 4 from the flush or flush-mounted non-use position to the actuation position as soon as a user approaches the door handle assembly 3 or handle 4. It can be seen from FIG. 3 that the handle 4 arranged in its actuation position is arranged on the outside on the door 2 of the motor vehicle 1, wherein the handle 4 can be gripped from behind by a user. The handle 4 is thus arranged so as to protrude relative to the outer contour 8 of the vehicle door 2 in the actuation position in comparison to the non-use position and can be actuated by the user in order to open the vehicle door 2. To couple the handle 4 to the vehicle door 2, a frame-like handle support 9 is provided, which is only shown schematically and in dashed lines in FIG. 3, since it is arranged on the inside of the vehicle door 2 and thus covered by the vehicle door 2 in FIGS. 1 and 2. The handle support 9 is secured to the inside of the vehicle door 2 via known securing means and supports the handle 4. In other words, the handle support 9, which can be secured to the vehicle door 2, is known to be used for attaching and mounting the handle 4 and is secured to the inside of the door 2 by means of screw connections (not shown in detail).

FIGS. 5 to 10 show different embodiments of the door handle assembly 3 according to the invention, wherein FIGS. 5 and 6 show a first embodiment, and FIGS. 7 to 10 show a second embodiment. All embodiments have in common that a first longitudinal end 10 of the handle 4 mounted on the handle support 9 is coupled to a first lever mechanism 11 so as to transmit a movement and a second longitudinal end 12 of the handle 4 is coupled to a second lever mechanism 14 so as to transmit a movement. In all embodiments, the first lever mechanism 11 has a first pivot axis 15, which is mounted on the handle support 9, the first pivot axis 15 alternatively also being able to be mounted on the vehicle door 2. Furthermore, the first lever mechanism 11 has a first joint axis 16 which is arranged at the first longitudinal end 10 of the handle 4 and which is coupled to the first pivot axis 15 so as to transmit a movement. The first joint axis 16 is mounted on the handle 4, such that the first joint axis 16 is moved with the handle 4 when the handle 4 moves from the non-use position into the actuation position. Furthermore, in all embodiments, the second lever mechanism 14 has a second pivot axis 17, which is arranged fixed on the handle support 9 or alternatively on the vehicle door 2. The second pivot axis 17 also includes a second joint axis 18, which is coupled to the second longitudinal end 12 of the handle 4, wherein the second joint axis 18 is further coupled to the second pivot axis 17 so as to transmit a movement. Furthermore, in the embodiments shown in FIGS. 5 to 10, the second pivot axis 17 is coupled to the first lever mechanism 11 via a coupling rod 19 so as to transmit a movement.

In the first embodiment of the door handle assembly 3 according to the invention, which is shown in FIGS. 5 and 6, the second pivot axis 17 is driven by a motor, wherein for this purpose a cam disk 20 is mounted on the second pivot axis 17 of the second lever mechanism 14 so that the cam disc 20 is motor-driven via the second pivot axis 17. The second joint axis 18 is mounted on the cam disc 20 offset to the second pivot axis 17. Furthermore, the coupling rod 19 is connected in an articulated manner to the second articulated axis 18, the second lever mechanism 14 having a movement lever 21 which is connected in a rotationally fixed manner to the second pivot axis 17 and is therefore pivotably mounted on the second pivot axis 17, wherein the movement lever 21 is also coupled via the second joint axis 18 to the coupling rod 19 so as to transmit a movement. When the handle 4 moves from the non-use position (see FIG. 5) to the actuation position (see FIG. 6), the cam disc 20 pivots counterclockwise around the motor-driven second pivot axis 17, such that the second joint axis 18 and thus also the movement lever 21 likewise turn counterclockwise around the second pivot axis 17. In this embodiment, the second joint axis 18 is coupled via the movement lever 21 to the second longitudinal end 12 of the handle 4 so as to transmit a movement, such that the pivoting of the second joint axis 18 and the movement lever 21 which is non-rotatably connected to the second pivot axis 17 press the second longitudinal end 12 of the handle 4 into an opening direction 22 of the handle 4. At the same time, the first longitudinal end 10 of the handle 4 is also pushed in the opening direction 22, which is based on the coupling of the second lever mechanism 14 and the first lever mechanism 11 via the coupling rod 19. For this coupling purpose, the first lever mechanism 11 has a pivot lever element 23 having a first pivot arm 24 and a second pivot arm 25, wherein the first pivot arm 24 is connected in an articulated manner to the first joint axis 16 and the second pivot arm 25 is connected in an articulated manner to the coupling rod 19. In the embodiment shown, the first pivot arm 24 and the second pivot arm 25 are arranged at an angle of 90° to one another, wherein alternatively a different angle between the two pivot arms 24, 25 is also conceivable. When the handle 4 moves from the non-use position into the actuation position, the coupling rod 19 mounted on the cam disc 20 pulls on the second pivot arm 25 of the pivot lever element 23 and pivots the pivot lever element 23 clockwise about the first pivot axis 15. As a result, the first pivot arm 24 presses the first joint axis 16 and thus the first longitudinal end 10 of the handle 4 in the opening direction 22. Consequently, the movement lever 21 pivots in a direction pointing away from the first pivot axis 15 during the movement of the handle 4 from the non-use position into the actuation position, wherein the coupling rod 19 pivots the pivot lever element 23 about the first pivot axis 15 such that the first joint axis 16 moves in the opening direction 22 of the handle 4.

FIGS. 7 and 8 show a second embodiment of the door handle assembly 3 according to the invention, wherein FIGS. 9 and 10 show an alternative modification of the second embodiment. In the second embodiment, the first pivot axis 15 and the second pivot axis 17 are designed as a respective floating bearing, which are linearly movable in a longitudinal direction 26 of the handle 4 when the handle 4 is moved from the non-use position towards the actuation position. In contrast to the first embodiment, in the second embodiment (see FIGS. 7 and 8) and the alternatives of the second embodiment (see FIGS. 9 and 10), the first pivot axis 15 is driven by a motor. To move the handle 4, a push crank 27 drives the first pivot axis 15 and moves the first pivot axis 15 linearly in the longitudinal direction 26 of the handle 4. Since the first pivot axis 15 and the second pivot axis 17 are coupled together so as to transmit a movement via the coupling rod 19, the first pivot axis 15 also moves the second pivot axis 17 when the first pivot axis 15 is driven by the push crank 27 during a movement of the handle 4. To release the handle 4 from the non-use position into the actuation position, the first lever mechanism 11 has a first extension lever 28 which couples the first pivot axis 15 to the first joint axis 16. Furthermore, the second lever mechanism 14 has a second extension lever 29 which couples the second pivot axis 17 to the second joint axis 18. The push crank 27 moves the first pivot axis 15 and the second pivot axis 17 linearly in the longitudinal direction 26 of the handle 4 and thereby presses the first and the second extension lever 28, 29 in an opening direction 22 of the handle 4 when the handle 4 moves from the non-use position into the actuation position, such that the handle is moved from the non-use position into the actuation position. To increase the stability of the movement guidance of the handle 4, a stabilization lever 30 is provided in the examples shown in FIGS. 7 to 10, which extends between the first joint axis 16 and the second joint axis 18 and is connected to the first and second joint axes 16, 18. The first joint axis 16 and the second joint axis 18 are arranged on the handle 4, such that the first joint axis 16 and the second joint axis 18 move with the handle 4 when the handle 4 is moved. In the second embodiment, the coupling rod 19, the first extension lever 28, the second extension lever 29 and the stabilization lever 30 are arranged in the non-use position of the handle 4 in the manner of a parallelogram, in which the coupling rod 19 extends parallel to the stabilization lever 30, whereas the first extension lever 28 extends parallel to the second extension lever 29. In the embodiment shown in FIGS. 7 and 8, when the handle 4 moves from the non-use position, the angle between the coupling rod 19 and the first extension lever 28 increases, wherein the angle is still an acute angle, i.e. an angle of less than 90°. In contrast, in the alternative of the second embodiment (see FIGS. 9 and 10), it is provided that in the non-use position the angle between the coupling rod 19 and the first extension lever 28 is 90°, which means that the alternative shown in FIGS. 9 and 10 differs from the second embodiment according to FIGS. 7 and 8.

In summary, the present invention provides a door handle assembly which, in contrast to the devices known from the prior art, is distinguished by a small installation depth. The door handle assembly described above comprises the handle support 9 which can be secured to the vehicle door 2, the handle 4 which is mounted on the handle support 9 and arranged so as to run flush with the outer contour 8 of the vehicle door 2 in a non-use position and which is designed to be movable into an actuation position by a user for actuation, and the first lever mechanism 11 which is coupled to the first longitudinal end 10 of the handle 4 so as to transmit a movement, and the second lever mechanism 14 which is coupled to the second longitudinal end 12 of the handle 4 so as to transmit a movement. The handle 4 is arranged so as to protrude relative to the outer contour 8 of the vehicle door 2 in the actuation position in comparison to the non-use position and can be actuated by the user in order to open the vehicle door 2. The first lever mechanism 11 has a first pivot axis 15 which is arranged on the handle support 9. According to the invention, the first lever mechanism 11 has the first joint axis 16 which is arranged on the handle 4, and the second lever mechanism 14 has the second joint axis 18 which is coupled to the handle 4 so as to transmit a movement, and has the second pivot axis 17 which is arranged on the handle support 9 and which is coupled to the first lever mechanism 11 via a coupling rod 19 so as to transmit a movement, the first pivot axis 15 or the second pivot axis 17 being driven by a motor.

1. Door handle assembly of a vehicle door, having a handle support which can be secured to the vehicle door, a handle which is mounted on the handle support and arranged so as to run flush with the outer contour of the vehicle door in a non-use position and which is designed to be movable into an actuation position by a user for actuation, and a first lever mechanism which is coupled to the first longitudinal end of the handle so as to transmit a movement, and a second lever mechanism which is coupled to the second longitudinal end of the handle so as to transmit a movement,
wherein the handle is arranged so as to protrude relative to the outer contour of the vehicle door in the actuation position in comparison to the non-use position and can be actuated by the user in order to open the vehicle door, and
wherein the first lever mechanism has a first pivot axis which is arranged on the handle support,
wherein
the first lever mechanism has a first joint axis which is arranged on the handle, and the second lever mechanism has a second joint axis which is coupled to the handle so as to transmit a movement, and has a second pivot axis which is arranged on the support and which is coupled to the first lever mechanism via a coupling rod so as to transmit a movement, the first pivot axis or the second pivot axis being driven by a motor.

2. Door handle assembly according to claim 1, wherein the first lever mechanism has a pivot lever element having a first pivot arm and a second pivot arm, wherein the first pivot arm is connected in an articulated manner to the first joint axis and the second pivot arm is connected in an articulated manner to the coupling rod.

3. Door handle assembly according to claim 2, wherein the second lever mechanism has a movement lever which is pivotally mounted on the second pivot axis and which is coupled to the coupling rod via the second joint axis so as to transmit a movement.

4. Door handle assembly according to claim 3, wherein the movement lever is rotatably connected to the second pivot axis, and a cam disc drives the second pivot axis for moving the handle, whereby the movement lever pivots in a direction pointing away from the first pivot axis during a movement of the handle from the non-use position into the actuation position and the coupling rod pivots the pivot lever element about the first pivot axis such that the first joint axis moves in an opening direction of the handle.

5. Door handle assembly according to claim 2, wherein the first pivot axis and the second pivot axis are linearly movable along a longitudinal direction of the handle on the handle support, whereby a push crank drives and linearly moves the first pivot axis for moving the handle.

6. Door handle assembly according to claim 5, wherein the first pivot axis and the second pivot axis are coupled together so as to transmit a movement via the coupling rod, such that a movement of the first pivot axis moves also the second pivot axis.

7. Door handle assembly according to claim 6, wherein the first lever mechanism has a first extension lever which couples the first pivot axis to the first joint axis.

8. Door handle assembly according to claim 7, wherein the second lever mechanism has a second extension lever which couples the second pivot axis to the second joint axis.

9. Door handle assembly according to claim 8, wherein the push crank moves the first pivot axis and the second pivot axis linearly and thereby presses the first and the second extension lever in an opening direction of the handle when the handle moves from the non-use position into the actuation position.
